(19) United States
(12) Patent Application Publication
(10) Pub. No.: US 2026/0239066 A1
(43) Pub. Date: Aug. 13, 2026

(54) METHODS AND NODES FOR SRS OUTPUT POWER INDICATION

(71) Applicant: TELEFONAKTIEBOLAGET LM ERICSSON (PUBL), Stockholm (SE)

(72) Inventors: Andreas NILSSON, Göteborg (SE); Mattias FRENNE, Stockholm (SE); Siva MURUGANATHAN, Ottawa (CA); Sven JACOBSSON, Göteborg (SE)

(21) Appl. No.: 19/150,589

(22) PCT Filed: Jan. 23, 2024
(86) PCT No.: PCT/IB2024/050645

§ 371 Date: Jul. 24, 2025

Related U.S. Application Data
(60) Provisional application No. 63/440,763, filed on Jan. 24, 2023.

(51) Int. Cl. H04W 24/10; H04B 17/318

(52) U.S. Cl. CPC H04W 24/10; H04B 17/328

(57) ABSTRACT

There is provided a method performed by a user equipment (UE) in communication with a network node. The method comprises: receiving a sounding reference signal (SRS) configuration, the SRS configuration comprising at least two SRS ports; and sending a power report to the network node, the power report comprising information of a power relation between at least two different SRS ports, wherein the power report is associated with a transmission of the at least two SRS ports.

### RELATED APPLICATION

This application claims the benefits of priority of U.S. Provisional Patent Application No. 63/440,763, entitled “Method for SRS output power indication” and filed at the United States Patent and Trademark Office (USPTO) on Jan. 24, 2023, which is hereby incorporated by reference in its entirety.

### BACKGROUND

### Sounding Reference Signal (SRS)

In New Radio (NR), SRS is used for providing Channel State Information (CSI) to the gNodeB (gNB) in the uplink (UL). The usage of SRS includes, e.g., deriving the appropriate transmission/reception beams and/or to perform link adaptation (i.e., setting the transmission rank and the Modulation and Coding Scheme (MCS)), and for selecting downlink (DL) (e.g., for Physical Downlink Shared Channel (PDSCH) transmissions) and UL (e.g., for Physical Uplink Shared Channel (PUSCH) transmissions) Multiple-Input Multiple-Output (MIMO) precoding.

In Long Term Evolution (LTE) and NR, the SRS is configured via Radio Resource Control (RRC), where parts of the configuration can be updated (for reduced latency) through Medium Access Control (MAC)-Control Element (CE) signaling. The configuration includes, for example, the SRS resource allocation (the physical mapping and the sequence to use) as well as the time-domain behavior (aperiodic, semi-persistent, or periodic). For aperiodic SRS transmission, the RRC configuration does not activate an SRS transmission from the User Equipment (UE) but instead a dynamic activation trigger is transmitted from the gNB in the DL, via the Downlink Control Information (DCI) in the Physical Downlink Control Channel (PDCCH) which instructs the UE to transmit the SRS once, at a predetermined time.

When configuring SRS transmissions, the gNB configures, through the SRS-Config Information element (IE), a set of SRS resources and a set of SRS resource sets, where each SRS resource set contains one or more SRS resources.

### SRS Configuration

Each SRS resource is configured with RRC (see for example Third Generation Partnership Project (3GPP) Technical Specification (TS) 38.331 version 16.1.0).

An SRS resource is configurable with respect to, e.g.,
1) The number of SRS ports (1, 2, or 4), configured by the RRC parameter nrofSRS-Ports.
2) The transmission comb (i.e., mapping to every 2^{nd}, 4^{th} or 8^{th} subcarrier), configured by the RRC parameter transmissionComb, which includes:
   a. The comb offset, configured by the RRC parameter combOffset, is specified (i.e., which of the combs that should be used).
   b. The cyclic shift, configured by the RRC parameter cyclicShift, that configures a (port-specific, for multi-port SRS resources) cyclic shift for the Zadoff-Chu sequence that is used for SRS. The use of cyclic shifts increases the number of SRS resources that can be mapped to a comb (as SRS sequences are designed to be (almost) orthogonal under cyclic shifts), but there is a limit on how many cyclic shifts that can be used (8 for comb 2, 12 for comb 4 and 6 for comb 8).
3) The time-domain position within a given slot, configured with the RRC parameter resourceMapping, which includes:
   a. The time-domain start position, which is limited to be one of the last 6 symbols (in NR Release (Rel)-15) or in any of the 14 symbols in a slot (in NR Rel-16 and 17), configured by the RRC parameter startPosition.
   b. The number of symbols for the SRS resource (that can be set to 1, 2 or 4), configured by the RRC parameter nrofSymbols (extended to up to 14 OFDM symbols inRel-17).
   c. The repetition factor (that can be set to 1, 2 or 4), configured by the RRC parameter repetitionFactor. When the repetition factor is larger than 1, the same frequency resources are used multiple times across symbols, used to improve the coverage as this allows more energy to be collected by the receiver. The repetition factor was extended to include the following values in Rel-17:1,2,4,5,6,7,8,10,12,14.
4) The sounding bandwidth, frequency-domain position and shift, and frequency-hopping pattern of an SRS resource (i.e., which part of the transmission bandwidth that is occupied by the SRS resource) is set through the RRC parameters freqDomainPosition, freqDomainShift, and the freqHopping parameters c-SRS, b-SRS, and b-hop. The smallest possible sounding bandwidth is 4 Resource Blocks (RBs).
5) The RRC parameter resourceType determines whether the SRS resource is transmitted as periodic, aperiodic (single transmission triggered by DCI), or semi persistent (same as periodic except for the start and stop of the periodic transmission is controlled through MAC-CE signaling instead of RRC signaling).
6) The RRC parameter sequenceId specifies how the SRS sequence is initialized.
7) The RRC parameter spatialRelationInfo configures the spatial relation for the SRS beam with respect to another Reference Signal (RS) (which could be another SRS, a Synchronization Signal Block (SSB) or a CSI-RS). If an SRS resource has a spatial relation to another SRS resource, then this SRS resource should be transmitted with the same beam (i.e., virtualization or spatial Transmission filter) as the one used to transmit the indicated SRS resource.

An SRS resource set is configured in RRC (see 3GPP TS 38.331 version 16.1.0).

SRS resource(s) will be transmitted as part of an SRS resource set, where all SRS resources in the same SRS resource set must share the same resource type.

The resource usage, which is configured by the RRC parameter usage sets constraints and assumptions on the resource properties (see 3GPP TS 38.214 for further details). SRS resource sets can be configured with one of four different usages: ‘antennaSwitching’, ‘codebook’, ‘nonCodebook’ and ‘beamManagement’.
a) An SRS resource set that is configured with usage ‘antennaSwitching’ is used for reciprocity-based DL precoding (i.e., used to sound the channel in the UL so that the gNB can use reciprocity to set a suitable DL precoders). The UE is expected to transmit one SRS port per UE antenna port.
b) An SRS resource set that is configured with usage ‘codebook’ is used for codebook (CB)-based UL transmission (i.e., used to sound the different UE antennas and help the gNB to determine/signal a suitable UL precoder, transmission rank, and MCS for PUSCH transmission). There are up to two SRS resources in an SRS resource set with usage ‘codebook’. How SRS ports are mapped to UE antenna ports is, however, up to UE implementation and not known to the gNB.
c) An SRS resource set that is configured with usage ‘nonCodebook’ is used for NonCodebook (NCB)-based UL transmission. Specifically, the UE transmits one SRS resource per candidate beam (suitable candidate beams are determined by the UE based on CSI-RS measurements in the DL and, hence, reciprocity needs to hold). The gNB can then, by indicating a subset of these SRS resources, determine which UL beam(s) that the UE should apply for PUSCH transmission. One UL layer will be transmitted per indicated SRS resource. Note that how the UE maps SRS ports to antenna ports is up to UE implementation and not known to the gNB.
d) An SRS resource set that is configured with usage ‘beamManagement’ is used (mainly for frequency bands above 6 GHz (i.e., for FR2)) to evaluate different UE beams for analog beamforming arrays. The UE transmits one SRS resource per analog beam, and the gNB will perform a Reference Signal Received Power (RSRP) measurement per transmitted SRS resource and, in this way, determine a suitable UE beam that is reported to the UE.

To summarize, the SRS resource-set configuration determines, e.g., usage, power control, and slot offset for aperiodic SRS. The SRS resource configuration determines the time-and-frequency allocation, the periodicity and offset, the sequence, and the spatial-relation information.

### SRS Antenna Switching

It is desirable for the gNB to sound all UE antennas (where sounding an antenna means transmitting an SRS from that antenna, which, in turn, enables the gNB to estimate the channel between the UE antenna and the antennas at the gNB), but it is costly to equip the UE with many transmit ports. SRS antenna switching was introduced in NR Rel-15, for several different UE architectures for which the number of receive chains is larger than the number of transmit chains. If a UE supports antenna switching, it will report so by means of UE-capability signaling.

The left column of Table 1 (from 3GPP 38.306) lists SRS antenna-switching capabilities that can be reported from a UE in NR Rel-15. For example, if a UE reports tlr2 in the UE-capability signaling, it means that it has two receive antennas (i.e., two receive chains) but only has the possibility of transmitting from one of those antennas at a time (i.e., one transmission chain) with support for antenna switching. In this case, two single-port SRS resources can be configured to the UE such that it can sound both antennas connected to the receive ports using a single transmit port with an antenna switch in between.

Additional UE capabilities were further introduced in NR Rel-16, see the right column of Table 1, which indicates support for the UE to be configured with SRS resource set(s) with usage ‘antennaSwitching’ but where only a subset of all UE antennas is sounded. For example, the UE capability tlr1-tlr2 means that the gNB can configure one single-port SRS resource (same as no antenna-switching capability) or two single-port SRS resources (same as for the capability “tlr2” described above) with usage ‘antennaSwitching’ per SRS resource set. In this case, if the UE is configured with a single SRS resource (no antenna switching) it will sound only one of its two antennas, which will save UE power consumption at the cost of reduced channel knowledge at the gNB (since the gNB can only estimate the channel between itself and the UE based on one of the two UE antennas).

TABLE 1
SRS antenna-switching capabilities supported by the UE

| | supportedSRS-TxPortSwitch- |
|---|---|
| supportedSRS-TxPortSwitch | v1610 |
| t1r2 | t1r1-t1r2 |
| t1r4 | t1r1-t1r2-t1r4 |
| t2r4 | t1r1-t1r2-t2r2-t2r4 |
| t2r2 | t1r1-t2r2 |
| t4r4 | t1r1-t2r2-t4r4 |
| t1r4-t2r4 | t1r1-t1r2-t2r2-t1r4-t2r4 |

### SUMMARY

There currently exist certain challenge(s).

In NR Rel. 15 for SRS with usage ‘antenna Switching’, the SRS transmitted from any antenna other than the “primary” antenna can have reduced maximum output power of between 3 to 7.5 dB compared to the SRS output power for the “primary” antenna, as shown in Table 2, which is an excerpt from 3GPP TS 38.101-1 version 16.8.0. Note that the power difference between the primary antenna and non-primary antennas used by a UE is not known to the network.

TABLE 2
Clause 6.2.4 of 38.101-1 version 16.8.0

```
6.2.4 Configured transmitted power
The UE is allowed to set its configured maximum output power P_{CMAX,f,c} for carrier f of serving cell
c in each slot. The configured maximum output power P_{CMAX,f,c} is set within the following bounds:
          P_{CMAX}_{_{—}}_{L,f,c} ≤ P_{CMAX,f,c} ≤ P_{CMAX}_{_{—}}_{H,f,c} with
  P_{CMAX}_{_{—}}_{L,f,c} = MIN {P_{EMAX,c}− ΔT_{C,c}, (P_{PowerClass} − ΔP_{PowerClass}) − MAX(MAX(MPR_{c}+ΔMPR_{c}, A-MPR_{c})+ ΔT_{IB,c} +
            ΔT_{C,c} + ΔT_{RxSRS}, P-MPR_{c}) }
        P_{CMAX}_{_{—}}_{H,f,c} = MIN {P_{EMAX,c}, P_{PowerClass} − ΔP_{PowerClass} }
...
ΔT_{RxSRS} is applied when
```

| | |
|---|---|
| a) | UE transmits SRS to other than first SRS port when the SRS-TxSwitch capability is |
| | indicated as ‘1T2R′, ′1T4R′ or, ′1T4R/2T4R′ |
| b) | UE transmits SRS to other than first or second SRS port when the SRS-TxSwitch capability |
| | is indicated as ‘2T4R′ or ′1T4R/2T4R′, or |
| c) | UE transmits SRS to a DL-only carrier |

```
    The value of ΔT_{RxSRS} is 4.5dB for n79 and 3 dB for bands whose F_{UL}_{_{—}}_{high} is lower than the
    F_{UL}_{_{—}}_{low} of n79 when the device is capable of power class 3 in the band. The value of ΔT_{RxSRS} is
    7.5dB for n79 and 6 dB for bands whose F_{UL}_{_{—}}_{high} is lower than the F_{UL}_{_{—}}_{low} of n79 when the
    device is capable of power class 2 in the band.
    For other SRS transmissions ΔT_{RxSRS} is zero.
```

Since the gNB is not aware of the potential SRS output power difference between the primary antenna and non-primary antennas, the estimated channel used for DL reciprocity-based precoding becomes unreliable, which will reduce the DL performance.

Certain aspects of the disclosure and their embodiments may provide solutions to these or other challenges.

The embodiments provide different methods on how the UE can indicate information about SRS output power differences for antennas connected to different Receive (Rx) chains during SRS transmission used for DL CSI acquisition at the gNB. The solutions also cover the case when the UE can indicate when there is no power difference problem.

Also, the embodiments allow to convey useful SRS output power information to the gNB in a way that could maximize the reliability of the DL channel estimation while minimizing the signaling overhead. The embodiments provide several different methods with different amount of signaling overhead.

For example, there is provided a method in a UE for handling reference signals (e.g. SRS). The method may comprise: receiving a SRS configuration, the SRS configuration comprising configuration of at least two SRS ports; and sending a power report to the network node, the power report comprising information of a power relation between at least two different SRS ports, wherein the power report is associated with a transmission of the at least two SRS ports. A UE or wireless device for implementing this method is also provided. There is also provided a method in a network node for handling reference signals (e.g. SRS). The method may comprise: sending a SRS configuration to the UE, the SRS configuration comprising configuration for at least two SRS ports; and receiving a power report from the UE, the power report comprising information of power relation between the at least two SRS ports, wherein the power report is associated with a transmission of the at least two SRS ports. A network node for implementing this method is also provided.

Certain embodiments may provide one or more of the following technical advantage(s).

With the additional information about SRS output power differences between the reference signals for different antennas, the gNB can determine a more accurate channel estimate and thereby improved DL performance.

### BRIEF DESCRIPTION OF THE DRAWINGS

Exemplary embodiments will be described in more detail with reference to the following figures, in which:

FIG. 1 illustrates an example signaling diagram between a UE and a network node, according to an embodiment.

FIG. 2 illustrates a schematic example of an SRS output power report consisting of 4 absolute power values, one per SRS port, for a UE with an 1T4R SRS configuration.

FIG. 3 illustrates a schematic example of an SRS output power report consisting of one absolute power value and three relative power values, for a UE with an 1T4R SRS configuration.

FIG. 4 illustrates a schematic example of an SRS output power report consisting of three relative power values, for a UE with an 1T4R SRS configuration.

FIG. 5 illustrates a schematic example of an SRS output power report consisting of three relative power values compared to SRS port 0, and where the output power for the SRS port 0 is the SRS port with highest SRS output power, for a UE with an 1T4R SRS configuration.

FIG. 6 illustrates a schematic example of a UE TX chain design and switching network of a UE supporting 1T4R.

FIG. 7 illustrates a schematic example of an SRS output power report consisting of 4 absolute power values for each serving cell where one absolute output power value is reported per SRS port per serving cell (a UE with an 1T4R SRS configuration in both serving cells is assumed).

FIG. 8 illustrates an example of an SRS output power report consisting of one absolute power value per serving cell and three relative power values per serving cell, for a UE with an 1T4R SRS configuration in both serving cells.

FIG. 9 illustrates an example of an SRS output power report consisting of one absolute power value for a first serving cell, three relative power values for the first serving cell, and four relative power values for a second serving cell, for a UE with an 1T4R SRS configuration in both serving cells.

FIG. 10 illustrates an example of an SRS output power report consisting of only relative power values, for a UE with an 1T4R SRS configuration for each serving cell.

FIG. 11 illustrates an example of an SRS output power report consisting of only relative power values, for a UE with an 1T4R SRS configuration for each serving cell.

FIG. 12 illustrates a flow chart of a method in a UE, according to an embodiment.

FIG. 13 illustrates a flow chart of a method in a network node, according to an embodiment.

FIG. 14 shows an example of a communication system, according to an embodiment.

FIG. 15 shows a schematic diagram of a UE, according to an embodiment.

FIG. 16 shows a schematic diagram of a network node, according to an embodiment.

FIG. 17 illustrates a block diagram of a host.

FIG. 18 illustrates a block diagram illustrating a virtualization environment.

FIG. 19 shows a communication diagram of a host.

### DETAILED DESCRIPTION

Some of the embodiments contemplated herein will now be described more fully with reference to the accompanying drawings. Embodiments are provided by way of example to convey the scope of the subject matter to those skilled in the art.

Generally stated, the embodiments herein allow the UE to indicate, to the network (or network node), assistance information about when SRS measurements on multiple SRS ports are directly useful for reciprocity-based operations or when they cannot be reliably used for reciprocity based operations. Optionally, the UE may also indicate the related power differences between SRS ports or groups of SRS ports, which would allow the network to compensate for these differences when computing the downlink channel based on the uplink SRS measurements.

It should be noted that the term “power” refers to an output power or a transmission power of (or for) a reference signal, SRS port or SRS resource. Also, a SRS port can be used to designate a particular SRS.

Also, in terms of notation, 1T2R (one transmit and 2 receive) is used to denote the antenna switching configuration and tlr2 is used to denote the antenna switching capability. For example, the UE may signal capability for tlr2 and t2r2 antenna switching and be configured with 1T2R antenna switching.

For example, in one embodiment, the UE indicates to the network whether the SRS ports of the SRS resource(s) of one or more SRS resource set(s) configured for reciprocity-based operation (i.e., configured for antenna switching) have an SRS output power that is comparable (i.e., the relative power difference between SRS ports is sufficiently small). For instance, the Radio Access Network 4 (RAN4) requirements may specify that the power difference between the SRS ports in this case are within X dB where for example X can be around 1 or larger. The indication can be a UE capability signaling or it can be a dynamic signaling. The benefit of dynamic signaling is in scenarios where SRS power differences may depend on the (dynamically varying) SRS power control. For example, the power control setting could be such that the SRS power level has enough headroom from the UE's maximal output power for all SRS ports of the SRS resource(s) in an SRS resource set to be transmitted with the same output power. On the other hand, if the SRS output power is close to the maximum possible output power, then only a subset of all the SRS ports can provide this power level (e.g., due to insertion losses that may vary over the UE antennas) and hence the power difference occurs. For such cases, dynamic signaling is useful. Such indication signaling may be a Uplink Control information (UCI) or MAC CE message from the UE to the network. The indication may alternatively be implicit, by indicating to the network using higher layer signaling (e.g., UE capability signaling) that if the SRS power is closer than Y dB from the maximal output power (e.g., Y=5 dB) then the UE is not able to maintain an SRS power output for all SRS ports that are comparable (e.g., within X dB).

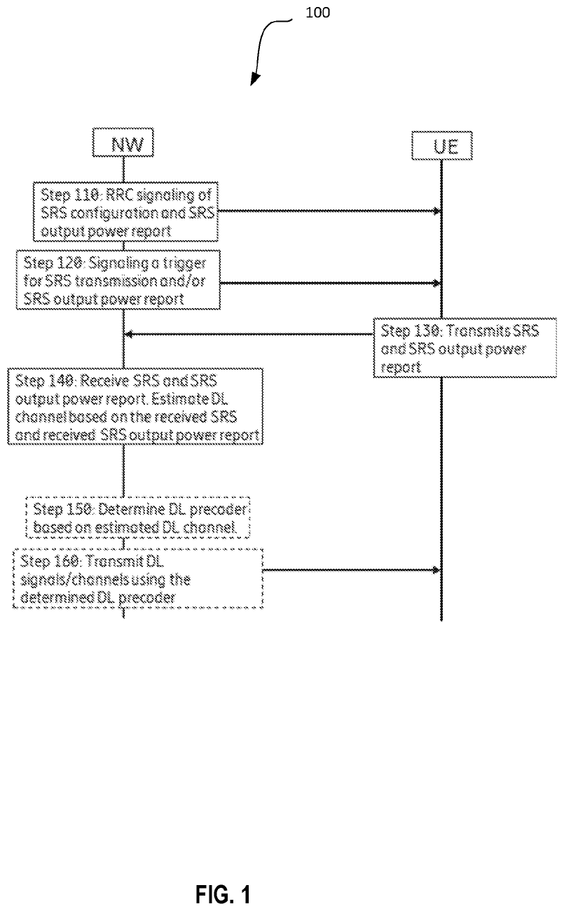

FIG. 1 illustrates a signaling diagram of a method 100 between a UE and a gNB (network node/network) for reporting an SRS power report, according to an embodiment. Method 100 comprises:

Step 110: the network (NW) configures the UE with an SRS configuration and a configuration for the SRS output power report, using RRC signalling, for example. As described in the background section, the SRS configuration may comprise a configuration of one or more SRS resource sets. Each SRS resource set may comprise one or more SRS resources and each SRS resource may comprise one or more SRS ports. As such, the SRS configuration may comprise the configuration of at least two SRS ports.

Step 120: the NW triggers the UE to transmit the SRS or SRS ports (not needed if the SRS transmission is periodic), and/or triggers the UE to signal the SRS output power report.

Step 130: the UE transmits the SRS (e.g. the SRS ports) and the SRS output power report. The UE may measure, calculate or estimate the power of the different SRS ports of the SRS resources. The UE may indicate the measured/calculated/estimated power of the different SRS ports in the report. The power can be used to transmit the SRS (or SRS ports) on each of the antennas of the network node, for example. As such, the power report is associated with the transmission of the SRS ports. Furthermore, the UE may also “know” the power of the SRS resources or their relative power, from implementation, for example.

As a note, the SRS could have been transmitted already before the UE receives the trigger of the SRS output power report.

Step 140: the NW receives the SRS and the SRS output power report. Based on the received SRS and the SRS output power report, the network can estimate the DL channel, by for example normalizing the channel gain associated with the multiple SRS ports based on the reported output power for the different SRS ports.

Step 150: (optional) the NW uses the DL channel estimates to determine a DL precoder.

Step 160: (optional) the NW transmits DL signals/channels using the determined DL precoder.

In some examples, in step 120, when SRS output power reports are dynamically indicated, the UE may transmit these reports via PUCCH or PUSCH in step 130.

It should be noted that the SRS output power report can be triggered by the network or it can be triggered by the UE.

### Examples Related to Network-Triggered SRS Output Power Report

In step 120, the network can trigger an SRS output power report, where the UE reports the difference in output power between different SRS ports (or reference signals) in SRS resource(s) in an SRS resource set according to the received RRC configuration (in step 110) from the network. The SRS output power report can further contain the information whether all ports can be transmitted with the same power or not (i.e., a true/false indication), given the current configuration obtained in step 110.

In one example, the trigger of the SRS output power report can be conveyed in a new field in DCI. Further, the SRS output power report can be associated with one or more of the aperiodic SRS trigger states, as specified by the parameter “aperiodicSRS-ResourceTrigger” or “aperiodicSRS-ResourceTriggerList” per SRS resource set in TS 38.331. For example, assume that the aperiodic SRS trigger state “1” is associated with an SRS output power report, then the SRS output power report will be triggered when the field “SRS Request” is equal to “1” in a DCI.

In one example, the SRS output power report can be associated with the latest SRS transmission of one or more SRS resource sets prior to the UE receiving the trigger of the SRS output power report. The SRS output power report can be also associated with the latest SRS transmission of one or more SRS resource sets used for DL CSI acquisition, i.e. with usage ‘antennaSwitching’ in NR, before receiving the trigger of the SRS output power report. In another example, the same DCI can trigger both the SRS transmission with usage ‘antennaSwitching’ and the SRS output power report. In this case, the SRS output power report might be associated with the triggered SRS transmission.

The report can indicate the output power difference between different SRS ports of an SRS transmission (where an SRS transmission for example can consist of one or more SRS resource(s) in one or more SRS resource set(s) with usage ‘antennaSwitching’). For example, the report indicates the output power difference between different SRS resources (this could be used in case we assume that the output power is split equally between all the SRS ports belonging to the same SRS resource). In another example, the report indicates the output power difference between different SRS ports of an SRS transmission, but only the output power for one of the SRS ports per SRS resource is indicated (this could be used in case we assume that the output power is split equally between all the SRS ports belonging to the same SRS resource). This would be similar to reporting power per SRS resource in terms of overhead signaling and useful information, except that the reported power per SRS resource might be the sum of the power of all the SRS port per SRS resource, while here we report the power of one of the SRS ports per SRS resource.

In the following, several examples/embodiments of the SRS output power report structure will be disclosed. Note that in these embodiments the SRS ports can belong to multiple different SRS resources and/or multiple different SRS resource sets, and the SRS port numbering might be based on for example the value of the SRS resource set identity/identifier (ID) and/or the value of the SRS resource ID which the SRS port belongs to. Even though a SRS port is used in the examples, the output power differences might be reported per SRS resource, or per single SRS port per SRS resource (i.e., in case there are two SRS ports per SRS resource, the SRS output power report only includes information about one of the SRS ports per SRS resource, which can save signaling overhead in case all the SRS ports per SRS resource is transmitted with the same power).

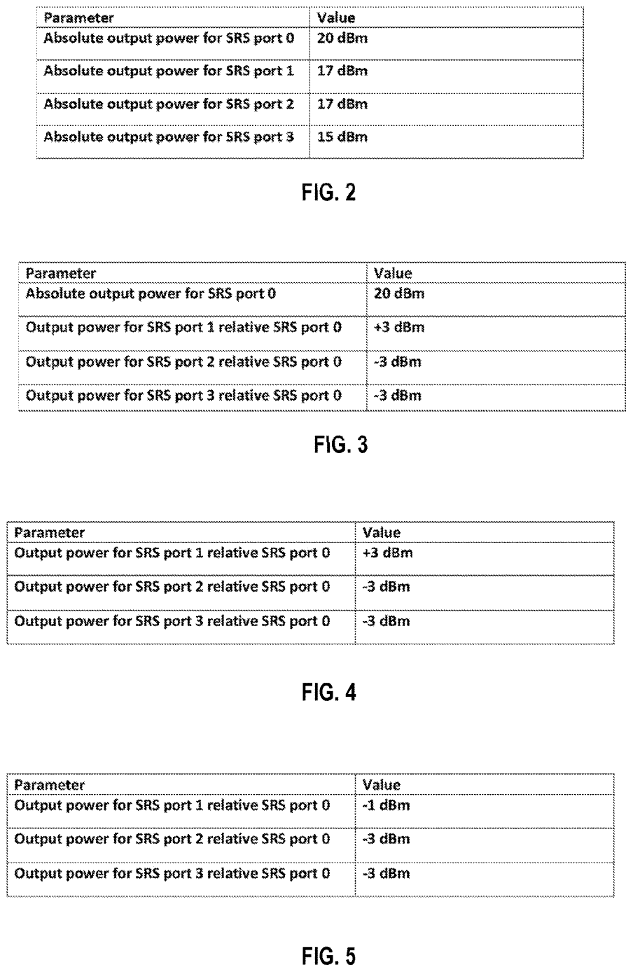

In one example, the absolute output power can be reported for each SRS port of an SRS transmission, as schematically illustrated in FIG. 2 for a 1T4R UE. One benefit with including the absolute SRS output power is that the network can determine the actual path gain of the channel, which could be useful when selecting modulation and coding for the subsequent DL transmission.

In one example, the absolute output power is reported for the strongest SRS port, and relative output power is reported for the remaining SRS ports, which can be used to reduce the reporting overhead since relative output power indication typically requires less bits compared to absolute output power indication, as schematically illustrated in FIG. 3 for a 1T4R UE. Note that the relative output power for the remaining SRS ports is with respect to the absolute power for the strongest SRS port (e.g., that of SRS port 0 in the example of FIG. 3).

In one example, only relative output power (e.g., relative to the SRS port 0) is reported. This could be used to save overhead even further, while still enabling the network to attain the relative output power between all the transmitted SRS ports. One example of this is illustrated in FIG. 4.

In one example, only relative output power is reported, and the relative output power is calculated relative to the SRS port with the strongest output power (e.g., the SRS port transmitted from the “primary” antenna). This example might require that the UE maps the SRS port 0 to the “primary” antenna, to enable the maximum output power for SRS Port 0. One benefit with this solution (in FIG. 5) compared to the solution in FIG. 4, is that the overhead signaling can be reduced, since only negative relative values are needed, which means that almost half the values and bits therefore can be removed (e.g. if the maximum relative value is assumed to be 3, then only 0, −1, −2 and −3 will be needed in this example, compared to +3, +2, +1 0 −1, −2 and 3 for the previous example).

In one example, to reduce overhead even further, the relative output power (e.g., relative to SRS port 0) is reported to be within or not within some pre-defined range (e.g., X dB) for SRS port(s) other than some reference SRS port, i.e., if the power difference is larger than X dB, it is reported that the relative power difference is not within a tolerable range and if the power difference is smaller than X dB, it is reported that that the relative power difference is within a tolerable range.

### Examples Related to UE Triggered SRS Output Power Report

In one example, the UE itself triggers the SRS output power report. For example, the UE can be configured by the network to transmit an SRS output power report when the SRS output power for different antennas (or different SRS ports) exceed a certain threshold. This could be useful for example if the UE is not UL power limited, and therefore can transmit with the same output power on all the antennas, and since the network knows that the UE will report if an output power difference is larger than a certain threshold, the network does not need to trigger any SRS output power reports.

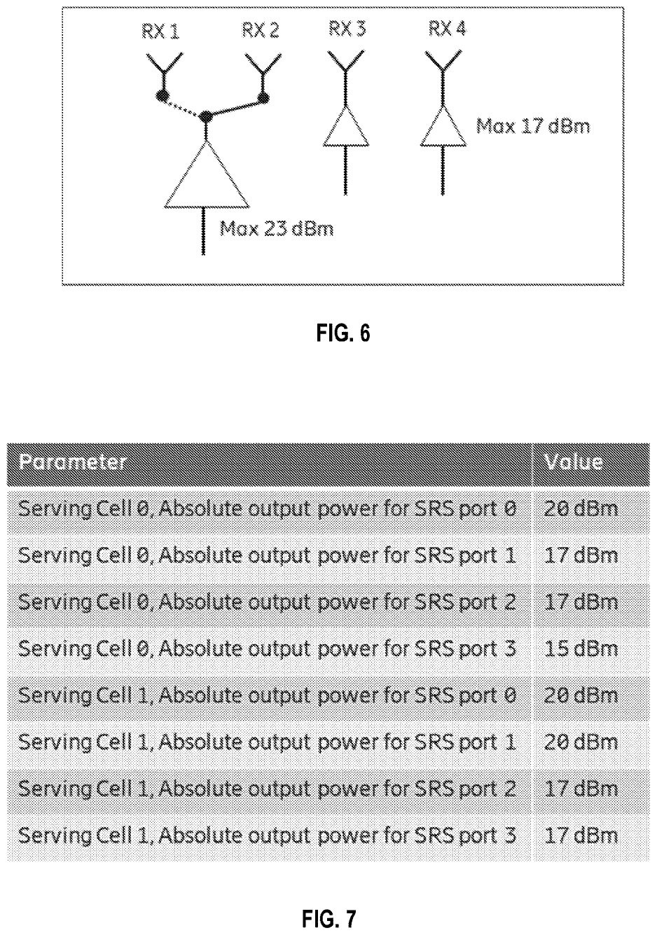

In one example, during UE capability signaling, the UE can indicate which output power difference it will use for different SRS ports (based on the available output power associated with different RX chains). For example, this will be described with reference to FIG. 6. In this case, the UE has 4 RX chains (i.e., 4 RX antennas), and has indicated support for 1T4R. The UE has one primary power amplifier (PA) supporting up to 23 dBm which can be used to switch between the antenna connected to RX chain 1 (RX1) and the antenna connected to RX chain 2 (RX2). In addition, the UE is equipped with two secondary PAs only supporting up to 17 dBm output power, and where each of these two PAs are connected to the antenna connected to RX chain 3 (RX3) and the antenna connected to RX chain 4 (RX4), respectively. In this case, the UE can during UE capability signaling indicate that SRS port 0 and SRS port 1 will support the maximum output power and SRS Port 2 and SRS Port 3 will be transmitted with 6 dB lower output power.

In one example, the UE always uses 6 dB lower output power for the antennas connected to RX3 and RX4 compared to the antennas connected to RX1 and RX2. In one example, in case the UE is not UL power limited, the UE uses an output power for the SRS transmitted from all 4 antenna ports as similar, that is as similar as possible between each other. Then, the network could for example use power head room reports to estimate how close the UE is to being UL power limited and, in this way, estimate the power difference between the SRS transmitted from the antennas associated with the different RX chains.

### Examples Related to SRS Output Power Reporting for Multiple Serving Cells

In one example, SRS output power reports corresponding to multiple serving cells are included in a single report. This is beneficial in the case where some of the serving cells are DL-only carriers and PUCCH or PUSCH transmission may not be possible in these serving cells. Hence, it is not possible for the UE to transmit SRS output power reports via PUCCH/PUSCH in these serving cells. Instead, the UE can transmit SRS output power reports corresponding to these DL-only serving cells on another serving cell that supports PUCCH/PUSCH transmission. In one example, the network may configure the UE to transmit SRS output power reports corresponding to serving cells x₁, x₂, . . . , x_{N} on serving cell x₁. In one example, the absolute output power is reported for respective SRS ports SRS transmissions corresponding to multiple serving cells, as schematically illustrated in FIG. 7 for a 1T4R UE.

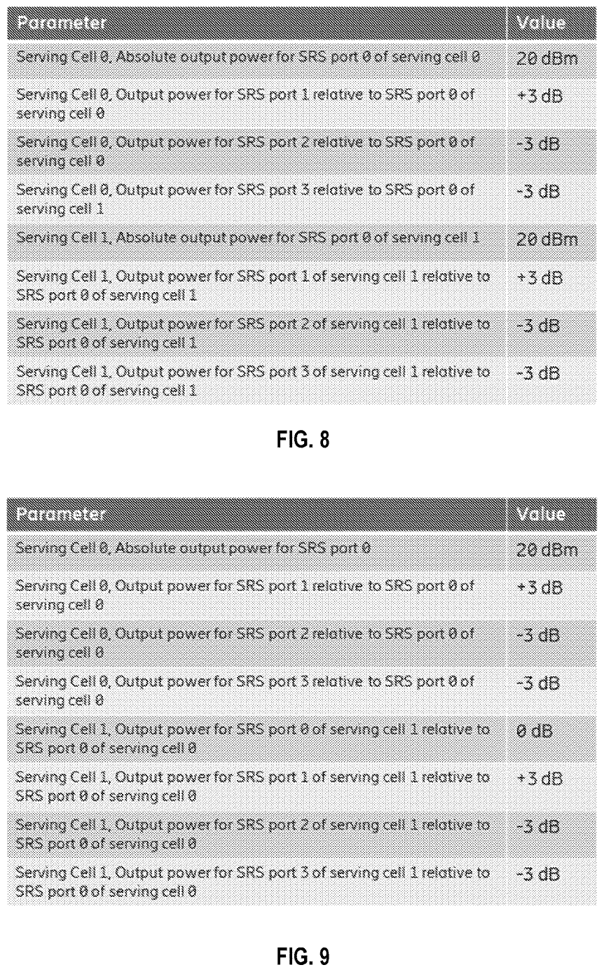

In one example, the absolute output power for each of the serving cells is reported for the strongest SRS port, and relative output power is reported for the remaining SRS ports in each serving cell as shown by the example in FIG. 8. In the example of this figure, it is assumed that SRS port 0 is the strongest SRS port in both serving cell 0 and serving cell 1. The relative output powers of SRS ports 1-3 in serving cell 0 are with respect to SRS port 0 in serving cell 0, and the relative output powers of SRS ports 1-3 in serving cell 1 are with respect to SRS port 0 in serving cell 1. By reporting relative output power for some of the SRS ports, the reporting overhead can be reduced, as relative output power reporting requires less bits compared to the absolute output power.

In one example, the absolute output power is only reported for the strongest SRS port in one of the serving cells, and relative output power is reported for the remaining SRS ports as shown by the example in FIG. 9. In this example, it is assumed that SRS port 0 is the strongest SRS port in serving cell 0. The relative output powers of SRS ports 1-3 in serving cell 0 and SRS ports 0-3 in serving cell 1 are with respect to SRS port 0 in serving cell 0.

In one example, only relative output power values are reported for multiple serving cells as this would save overhead even further when reporting the output power values for multiple serving cells.

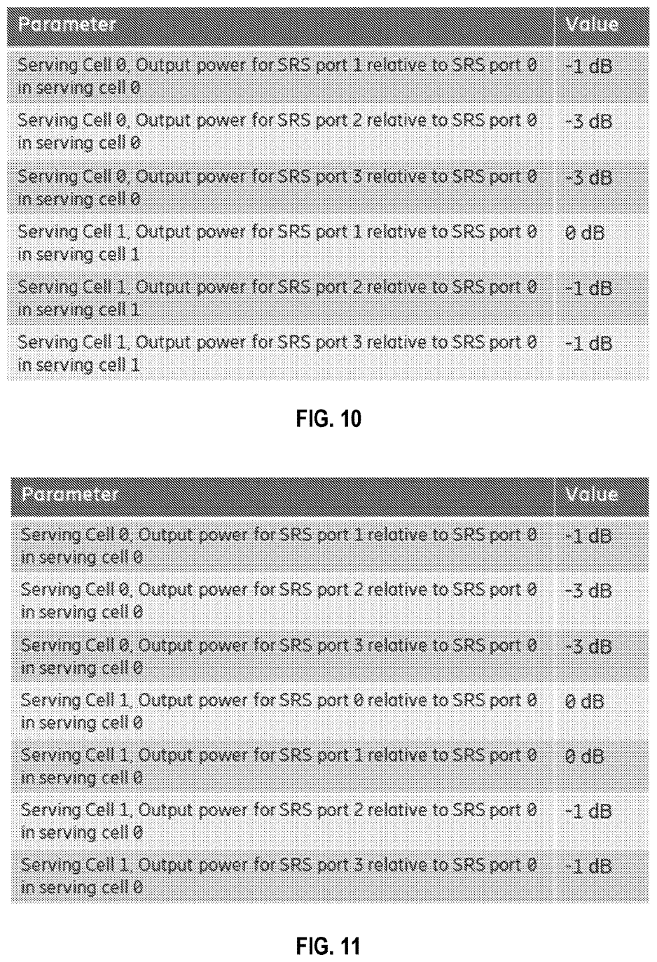

A first example of this is illustrated in FIG. 10. In this example, the output power for SRS ports 1-3 in serving cell 0 are relative to the output power for SRS port 0 in serving cell 0. Similarly, the output power for SRS ports 1-3 in serving cell 1 are relative to the output power for SRS port 0 in serving cell 1.

A second example of this is illustrated in FIG. 11. In this example, the output power for SRS ports 1-3 in serving cell 0 and SRS ports 0-3 in serving cell 1 are relative to the output power for SRS port 0 in serving cell 0.

The embodiments/examples related to SRS output power reporting for multiple serving cells can be either network triggered or UE triggered. As such, these embodiments can be combined with the embodiments/examples related to network triggered SRS output power reports or with the embodiments/examples related to UE triggered SRS output power reports as described above.

In some embodiments, only the SRS output power values for a subset of the serving cells for which the UE is configured to report SRS output power are included in the report. In some embodiments, only the SRS output power values corresponding to the serving cells in which SRS is transmitted recently (i.e., within a duration Ta) are included in the report. In some other embodiments, only the SRS output power values corresponding to the serving cells in which the UE triggering criterion (as described in above embodiments) is met are included in the report. In some other embodiments, only the SRS output power values corresponding to the serving cells in which a SRS transmission is triggered are included in the report.

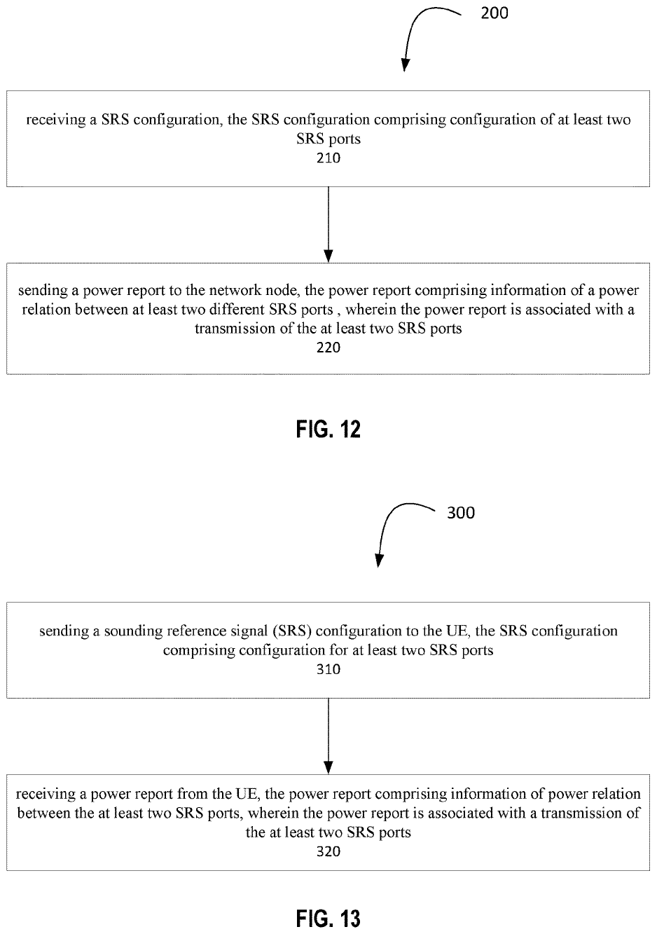

Now turning to FIG. 12, an exemplary flow chart of a method 200 in a UE such as UE 1500 or UE 1412, in communication with a network node, such as 1410 or 1600, for handling reference signals will be described. Method 200 comprises:

Step 210: receiving a SRS configuration, the SRS configuration comprising configuration of at least two SRS ports; and

Step 220: sending a power report to the network node, the power report comprising information of a power relation between at least two different SRS ports, wherein the power report is associated with a transmission of the at least two SRS ports.

In some examples, the at least two SRS ports can be contained in one or more SRS resource sets, or, in one or more SRS resources. In some examples, the UE may send one or more SRS to the network node, in accordance with the received SRS configuration. In some examples, the UE may further receive a configuration for the power report, from the network node. In some examples, the UE may receive a trigger from the network node to send the power report (e.g. via DCI). In some examples, the UE may further measure, calculate or estimate the power of the at least two SRS ports. In some examples, the power of a SRS port can be a transmission power or output power of the SRS. In some examples, the information of power relation between at least two SRS ports comprises a difference in the power between the at least two SRS ports. In some examples, the information of power relation between the at least two SRS ports comprises an indication that the one or more reference signals all have a same power. In some examples, the information of power relation between the at least two SRS ports comprises a difference in the power between SRS resources for the at least two SRS ports, when power is split equally between all SRS ports belonging to a same SRS resource. In some examples, the information of power relation between the at least two SRS ports comprises an absolute value of the power of each SRS port. In some examples, the information of power relation between the at least two SRS ports comprises an indication of a power value for a SRS port, if all the SRS ports have the same power. In some examples, the information of power relation between the at least two SRS ports comprises an indication of the power of the strongest SRS port and a power relative to the power of the strongest SRS port for the remaining SRS ports. In some examples, the information of power relation between the at least two SRS ports comprises an indication of a power relative to a power of a specific SRS port. In some examples, the information of power relation between the at least two SRS ports comprises an indication of a power relative to a power of the strongest SRS port. In some examples, the information of power relation between the at least two SRS ports comprises an indication of a power relative to a specific SRS port to be within a range. In some examples, the UE may determine that a power for one or more of the at least two SRS ports exceeds a threshold value. In some examples, the UE may further determine that a power difference between the at least two SRS ports exceeds a threshold value. In some examples, in response to either of the two determinations above, the UE may send the power report to the network node. In some examples, the UE may indicate a power difference to use for the at least two SRS ports, based on the power report, via dynamic signalling or UE capability. In some examples, the power report may comprise a plurality of power reports corresponding to multiple serving cells or a subset of a plurality of serving cells. In some examples, an absolute power for each of the multiple serving cells is reported for the strongest SRS port. In some examples, a relative power is reported for the remaining SRS ports in each serving cell. In some examples, the power report comprises a plurality of power reports corresponding to one or more serving cells in which a SRS port has been transmitted recently.

In some examples, the power report is associated with the latest transmission of one or more of the at least two SRS ports. In some examples, the UE may send the power report by sending a dynamic signalling, which can be a UCI or MAC-CE.

FIG. 13 illustrates an example of a flow chart of a method 300 in a network node, such as network node 1410 or 1600, in communication with a UE, such as UE 1500 or UE 1412, for handling reference signals. Method 300 comprises:

Step 310: sending a sounding reference signal (SRS) configuration to the UE, the SRS configuration comprising configuration for at least two SRS ports; and

Step 320: receiving a power report from the UE, the power report comprising information of power relation between the at least two SRS ports, wherein the power report is associated with a transmission of the at least two SRS ports.

In some examples, the at least two SRS ports can be contained in or more SRS resource sets, or, in one or more SRS resources. In some examples, the network node may receive one or more SRS from the UE, in accordance with the SRS configuration. In some examples, the network node may send a configuration for the power report. In some examples, the network node may send a trigger to the UE to send the power report. In some examples, the power of a SRS port can be a transmission power or output power of a SRS port. In some examples, network node may estimate a downlink channel based on the received one or more SRS and the received power report. In some examples, the information of power relation between the at least two SRS ports comprises a difference in the power between the at least two SRS ports. In some examples, the information of power relation between the at least two SRS ports comprises an indication that the at least two SRS ports have a same power. In some examples, the information of power relation between the at least two SRS ports comprises a difference in the power between SRS resources for the at least two SRS ports, when the power is split equally between all SRS ports belonging to a same SRS resource. In some examples, the information of power relation between the at least two SRS ports comprises an absolute value of the power of each SRS port. In some examples, the information of power relation between the at least two SRS ports comprises an indication of a power value for a SRS port, if all the SRS ports have the same power. In some examples, the information of power relation between the at least two SRS ports comprises an indication of the power of the strongest SRS port and a power relative to the power of the strongest SRS port for the remaining SRS ports. In some examples, the information of power relation between the at least two SRS ports comprises an indication of a power relative to a power of a specific SRS port. In some examples, the information of power relation between the at least two SRS ports comprises an indication of a power relative to a power of the strongest SRS port. In some examples, the information of power relation between the at least two SRS ports comprises an indication of a power relative to a specific SRS port to be within a range. In some examples, the power report comprises a plurality of power reports corresponding to multiple serving cells or a subset of a plurality of serving cells. In some examples, an absolute power for each of the multiple serving cells is reported for the strongest SRS port. In some examples, a relative power is reported for the remaining SRS ports in each serving cell. In some examples, the power report comprises a plurality of power reports corresponding to one or more serving cells in which a SRS port has been transmitted recently. In some examples, the power report is associated with the latest transmission of one or more of the at least two SRS ports. In some examples, network node receive the power report by receiving a dynamic signalling, which can be UCI or MAC-CE.

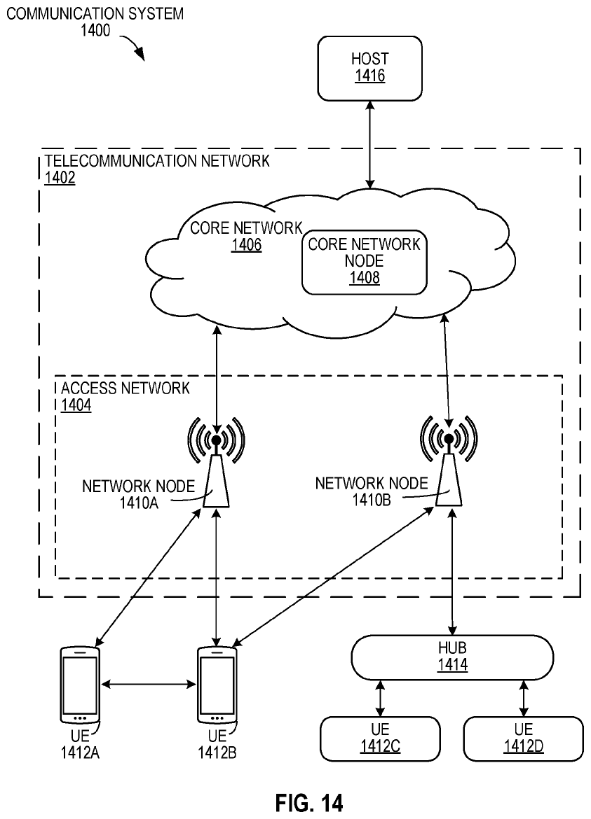

FIG. 14 shows an example of a communication system 1400 in accordance with some embodiments.

In the example, the communication system 1400 includes a telecommunication network 1402 that includes an access network 1404, such as a radio access network (RAN), and a core network 1406, which includes one or more core network nodes 1408. The access network 1404 includes one or more access network nodes, such as network nodes 1410a and 1410b (one or more of which may be generally referred to as network nodes 1410), or any other similar 3GPP access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 1402 includes one or more Open-RAN (ORAN) network nodes. An ORAN network node is a node in the telecommunication network 1402 that supports an ORAN specification (e.g., a specification published by the O-RAN Alliance, or any similar organization) and may operate alone or together with other nodes to implement one or more functionalities of any node in the telecommunication network 1402, including one or more network nodes 1410 and/or core network nodes 1408.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 1410 facilitate direct or indirect connection of user equipment (UE), such as by connecting UEs 1412a, 1412b, 1412c, and 1412d (one or more of which may be generally referred to as UEs 1412) to the core network 1406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1400 may include any number of wired or wireless networks, network nodes, UEs, and/or any other components or systems that may facilitate or participate in the communication of data and/or signals whether via wired or wireless connections. The communication system 1400 may include and/or interface with any type of communication, telecommunication, data, cellular, radio network, and/or other similar type of system.

The UEs 1412 may be any of a wide variety of communication devices, including wireless devices arranged, configured, and/or operable to communicate wirelessly with the network nodes 1410 and other communication devices. Similarly, the network nodes 1410 are arranged, capable, configured, and/or operable to communicate directly or indirectly with the UEs 1412 and/or with other network nodes or equipment in the telecommunication network 1402 to enable and/or provide network access, such as wireless network access, and/or to perform other functions, such as administration in the telecommunication network 1402.

In the depicted example, the core network 1406 connects the network nodes 1410 to one or more hosts, such as host 1416. These connections may be direct or indirect via one or more intermediary networks or devices. In other examples, network nodes may be directly coupled to hosts. The core network 1406 includes one more core network nodes (e.g., core network node 1408) that are structured with hardware and software components. Features of these components may be substantially similar to those described with respect to the UEs, network nodes, and/or hosts, such that the descriptions thereof are generally applicable to the corresponding components of the core network node 1408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1416 may be under the ownership or control of a service provider other than an operator or provider of the access network 1404 and/or the telecommunication network 1402, and may be operated by the service provider or on behalf of the service provider. The host 1416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1400 of FIG. 14 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1402 is a cellular network that implements 3GPP standardized features. Accordingly, the telecommunications network 1402 may support network slicing to provide different logical networks to different devices that are connected to the telecommunication network 1402. For example, the telecommunications network 1402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1412 are configured to transmit and/or receive information without direct human interaction. For instance, a UE may be designed to transmit information to the access network 1404 on a predetermined schedule, when triggered by an internal or external event, or in response to requests from the access network 1404. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) NR-Dual Connectivity (EN-DC).

In the example, the hub 1414 communicates with the access network 1404 to facilitate indirect communication between one or more UEs (e.g., UE 1412c and/or 1412d) and network nodes (e.g., network node 1410b). In some examples, the hub 1414 may be a controller, router, content source and analytics, or any of the other communication devices described herein regarding UEs. For example, the hub 1414 may be a broadband router enabling access to the core network 1406 for the UEs. As another example, the hub 1414 may be a controller that sends commands or instructions to one or more actuators in the UEs. Commands or instructions may be received from the UEs, network nodes 1410, or by executable code, script, process, or other instructions in the hub 1414. As another example, the hub 1414 may be a data collector that acts as temporary storage for UE data and, in some embodiments, may perform analysis or other processing of the data. As another example, the hub 1414 may be a content source. For example, for a UE that is a VR headset, display, loudspeaker or other media delivery device, the hub 1414 may retrieve VR assets, video, audio, or other media or data related to sensory information via a network node, which the hub 1414 then provides to the UE either directly, after performing local processing, and/or after adding additional local content. In still another example, the hub 1414 acts as a proxy server or orchestrator for the UEs, in particular if one or more of the UEs are low energy IoT devices.

The hub 1414 may have a constant/persistent or intermittent connection to the network node 1410b. The hub 1414 may also allow for a different communication scheme and/or schedule between the hub 1414 and UEs (e.g., UE 1412c and/or 1412d), and between the hub 1414 and the core network 1406. In other examples, the hub 1414 is connected to the core network 1406 and/or one or more UEs via a wired connection. Moreover, the hub 1414 may be configured to connect to an M2M service provider over the access network 1404 and/or to another UE over a direct connection. In some scenarios, UEs may establish a wireless connection with the network nodes 1410 while still connected via the hub 1414 via a wired or wireless connection. In some embodiments, the hub 1414 may be a dedicated hub—that is, a hub whose primary function is to route communications to/from the UEs from/to the network node 1410b. In other embodiments, the hub 1414 may be a non-dedicated hub—that is, a device which is capable of operating to route communications between the UEs and network node 1410b, but which is additionally capable of operating as a communication start and/or end point for certain data channels.

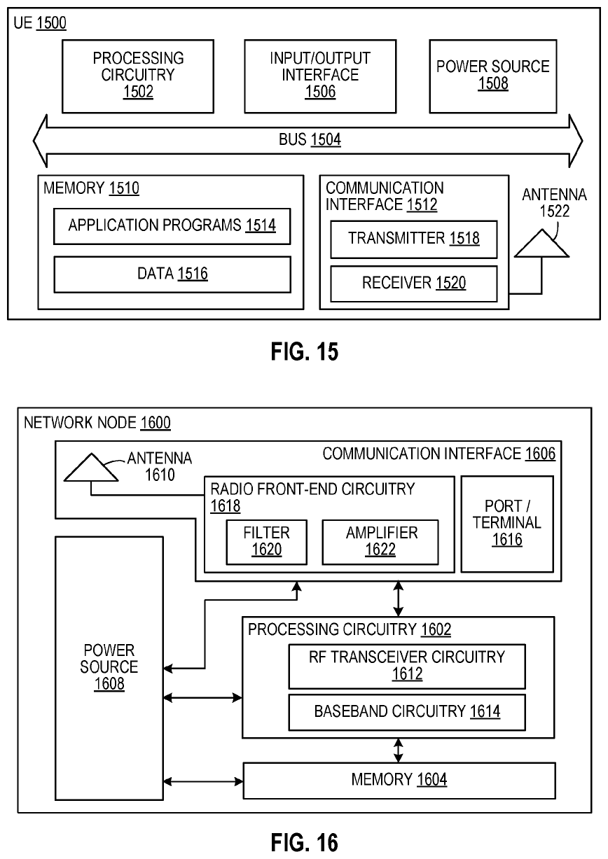

FIG. 15 shows a UE 1500 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1500 includes processing circuitry 1502 that is operatively coupled via a bus 1504 to an input/output interface 1506, a power source 1508, a memory 1510, a communication interface 1512, and/or any other component, or any combination thereof. Certain UEs may utilize all or a subset of the components shown in FIG. 15. The level of integration between the components may vary from one UE to another UE. Further, certain UEs may contain multiple instances of a component, such as multiple processors, memories, transceivers, transmitters, receivers, etc.

The processing circuitry 1502 is configured to process instructions and data and may be configured to implement any sequential state machine operative to execute instructions stored as machine-readable computer programs in the memory 1510. The processing circuitry 1502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1502 may include multiple central processing units (CPUs). The processing circuitry 1502 may be configured to perform any of the steps of method 200 of FIG. 12.

In the example, the input/output interface 1506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1508 is structured as a battery or battery pack. Other types of power sources, such as an external power source (e.g., an electricity outlet), photovoltaic device, or power cell, may be used. The power source 1508 may further include power circuitry for delivering power from the power source 1508 itself, and/or an external power source, to the various parts of the UE 1500 via input circuitry or an interface such as an electrical power cable. Delivering power may be, for example, for charging of the power source 1508. Power circuitry may perform any formatting, converting, or other modification to the power from the power source 1508 to make the power suitable for the respective components of the UE 1500 to which power is supplied.

The memory 1510 may be or be configured to include memory such as random access memory (RAM), read-only memory (ROM), programmable ROM (PROM), erasable PROM (EPROM), electrically EPROM (EEPROM), magnetic disks, optical disks, hard disks, removable cartridges, flash drives, and so forth. In one example, the memory 1510 includes one or more application programs 1514, such as an operating system, web browser application, a widget, gadget engine, or other application, and corresponding data 1516. The memory 1510 may store, for use by the UE 1500, any of a variety of various operating systems or combinations of operating systems.

The memory 1510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1510 may allow the UE 1500 to access instructions, application programs and the like, stored on transitory or non-transitory memory media, to off-load data, or to upload data. An article of manufacture, such as one utilizing a communication system may be tangibly embodied as or in the memory 1510, which may be or comprise a device-readable storage medium.

The processing circuitry 1502 may be configured to communicate with an access network or other network using the communication interface 1512. The communication interface 1512 may comprise one or more communication subsystems and may include or be communicatively coupled to an antenna 1522. The communication interface 1512 may include one or more transceivers used to communicate, such as by communicating with one or more remote transceivers of another device capable of wireless communication (e.g., another UE or a network node in an access network). Each transceiver may include a transmitter 1518 and/or a receiver 1520 appropriate to provide network communications (e.g., optical, electrical, frequency allocations, and so forth). Moreover, the transmitter 1518 and receiver 1520 may be coupled to one or more antennas (e.g., antenna 1522) and may share circuit components, software or firmware, or alternatively be implemented separately.

In the illustrated embodiment, communication functions of the communication interface 1512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1500 shown in FIG. 15.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 16 shows a network node 1600 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs (NBs), evolved NBs (eNBs) and NR NBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1600 includes a processing circuitry 1602, a memory 1604, a communication interface 1606, and a power source 1608. The network node 1600 may be composed of multiple physically separate components (e.g., a NodeB component and a RNC component, or a BTS component and a BSC component, etc.), which may each have their own respective components. In certain scenarios in which the network node 1600 comprises multiple separate components (e.g., BTS and BSC components), one or more of the separate components may be shared among several network nodes. For example, a single RNC may control multiple NodeBs. In such a scenario, each unique NB and RNC pair, may in some instances be considered a single separate network node. In some embodiments, the network node 1600 may be configured to support multiple radio access technologies (RATs). In such embodiments, some components may be duplicated (e.g., separate memory 1604 for different RATs) and some components may be reused (e.g., a same antenna 1610 may be shared by different RATs). The network node 1600 may also include multiple sets of the various illustrated components for different wireless technologies integrated into network node 1600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1600.

The processing circuitry 1602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1600 components, such as the memory 1604, to provide network node 1600 functionality.

In some embodiments, the processing circuitry 1602 includes a system on a chip (SOC). In some embodiments, the processing circuitry 1602 includes one or more of radio frequency (RF) transceiver circuitry 1612 and baseband processing circuitry 1614. In some embodiments, the radio frequency (RF) transceiver circuitry 1612 and the baseband processing circuitry 1614 may be on separate chips (or sets of chips), boards, or units, such as radio units and digital units. In alternative embodiments, part or all of RF transceiver circuitry 1612 and baseband processing circuitry 1614 may be on the same chip or set of chips, boards, or units. The processing circuitry 1614 is further configured to perform any of the steps of method 300 of FIG. 13.

The memory 1604 may comprise any form of volatile or non-volatile computer-readable memory including, without limitation, persistent storage, solid-state memory, remotely mounted memory, magnetic media, optical media, random access memory (RAM), ROM, mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1602. The memory 1604 may store any suitable instructions, data, or information, including a computer program, software, an application including one or more of logic, rules, code, tables, and/or other instructions capable of being executed by the processing circuitry 1602 and utilized by the network node 1600. The memory 1604 may be used to store any calculations made by the processing circuitry 1602 and/or any data received via the communication interface 1606. In some embodiments, the processing circuitry 1602 and memory 1604 is integrated.

The communication interface 1606 is used in wired or wireless communication of signaling and/or data between a network node, access network, and/or UE. As illustrated, the communication interface 1606 comprises port(s)/terminal(s) 1616 to send and receive data, for example to and from a network over a wired connection. The communication interface 1606 also includes radio front-end circuitry 1618 that may be coupled to, or in certain embodiments a part of, the antenna 1610. Radio front-end circuitry 1618 comprises filters 1620 and amplifiers 1622. The radio front-end circuitry 1618 may be connected to an antenna 1610 and processing circuitry 1602. The radio front-end circuitry may be configured to condition signals communicated between antenna 1610 and processing circuitry 1602. The radio front-end circuitry 1618 may receive digital data that is to be sent out to other network nodes or UEs via a wireless connection. The radio front-end circuitry 1618 may convert the digital data into a radio signal having the appropriate channel and bandwidth parameters using a combination of filters 1620 and/or amplifiers 1622. The radio signal may then be transmitted via the antenna 1610. Similarly, when receiving data, the antenna 1610 may collect radio signals which are then converted into digital data by the radio front-end circuitry 1618. The digital data may be passed to the processing circuitry 1602. In other embodiments, the communication interface may comprise different components and/or different combinations of components.

In certain alternative embodiments, the network node 1600 does not include separate radio front-end circuitry 1618, instead, the processing circuitry 1602 includes radio front-end circuitry and is connected to the antenna 1610. Similarly, in some embodiments, all or some of the RF transceiver circuitry 1612 is part of the communication interface 1606. In still other embodiments, the communication interface 1606 includes one or more ports or terminals 1616, the radio front-end circuitry 1618, and the RF transceiver circuitry 1612, as part of a radio unit (not shown), and the communication interface 1606 communicates with the baseband processing circuitry 1614, which is part of a digital unit (not shown).

The antenna 1610 may include one or more antennas, or antenna arrays, configured to send and/or receive wireless signals. The antenna 1610 may be coupled to the radio front-end circuitry 1618 and may be any type of antenna capable of transmitting and receiving data and/or signals wirelessly. In certain embodiments, the antenna 1610 is separate from the network node 1600 and connectable to the network node 1600 through an interface or port.

The antenna 1610, communication interface 1606, and/or the processing circuitry 1602 may be configured to perform any receiving operations and/or certain obtaining operations described herein as being performed by the network node. Any information, data and/or signals may be received from a UE, another network node and/or any other network equipment. Similarly, the antenna 1610, the communication interface 1606, and/or the processing circuitry 1602 may be configured to perform any transmitting operations described herein as being performed by the network node. Any information, data and/or signals may be transmitted to a UE, another network node and/or any other network equipment.

The power source 1608 provides power to the various components of network node 1600 in a form suitable for the respective components (e.g., at a voltage and current level needed for each respective component). The power source 1608 may further comprise, or be coupled to, power management circuitry to supply the components of the network node 1600 with power for performing the functionality described herein. For example, the network node 1600 may be connectable to an external power source (e.g., the power grid, an electricity outlet) via an input circuitry or interface such as an electrical cable, whereby the external power source supplies power to power circuitry of the power source 1608. As a further example, the power source 1608 may comprise a source of power in the form of a battery or battery pack which is connected to, or integrated in, power circuitry. The battery may provide backup power should the external power source fail.

Embodiments of the network node 1600 may include additional components beyond those shown in FIG. 16 for providing certain aspects of the network node's functionality, including any of the functionality described herein and/or any functionality necessary to support the subject matter described herein. For example, the network node 1600 may include user interface equipment to allow input of information into the network node 1600 and to allow output of information from the network node 1600. This may allow a user to perform diagnostic, maintenance, repair, and other administrative functions for the network node 1600.

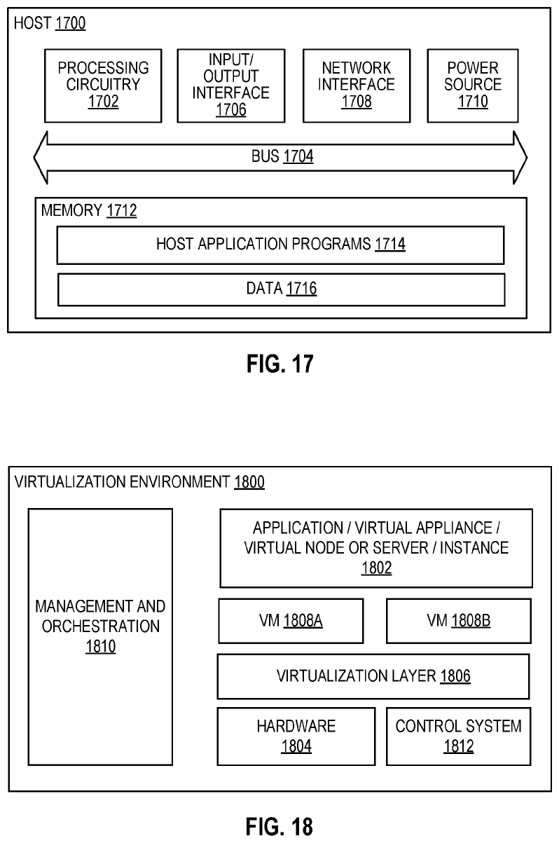

FIG. 17 is a block diagram of a host 1700, which may be an embodiment of the host 1416 of FIG. 14, in accordance with various aspects described herein. As used herein, the host 1700 may be or comprise various combinations hardware and/or software, including a standalone server, a blade server, a cloud-implemented server, a distributed server, a virtual machine, container, or processing resources in a server farm. The host 1700 may provide one or more services to one or more UEs.

The host 1700 includes processing circuitry 1702 that is operatively coupled via a bus 1704 to an input/output interface 1706, a network interface 1708, a power source 1710, and a memory 1712. Other components may be included in other embodiments. Features of these components may be substantially similar to those described with respect to the devices of previous figures, such as FIGS. 15 and 16, such that the descriptions thereof are generally applicable to the corresponding components of host 1700.

The memory 1712 may include one or more computer programs including one or more host application programs 1714 and data 1716, which may include user data, e.g., data generated by a UE for the host 1700 or data generated by the host 1700 for a UE. Embodiments of the host 1700 may utilize only a subset or all of the components shown. The host application programs 1714 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1714 may also provide for user authentication and licensing checks and may periodically report health, routes, and content availability to a central node, such as a device in or on the edge of a core network. Accordingly, the host 1700 may select and/or indicate a different host for over-the-top services for a UE. The host application programs 1714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 18 is a block diagram illustrating a virtualization environment 1800 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1800 includes components defined by the O-RAN Alliance, such as an O-Cloud environment orchestrated by a Service Management and Orchestration Framework via an O-2 interface.

Applications 1802 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1806 (also referred to as hypervisors or virtual machine monitors (VMMs)), provide VMs 1808a and 1808b (one or more of which may be generally referred to as VMs 1808), and/or perform any of the functions, features and/or benefits described in relation with some embodiments described herein. The virtualization layer 1806 may present a virtual operating platform that appears like networking hardware to the VMs 1808.

The VMs 1808 comprise virtual processing, virtual memory, virtual networking or interface and virtual storage, and may be run by a corresponding virtualization layer 1806. Different embodiments of the instance of a virtual appliance 1802 may be implemented on one or more of VMs 1808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1808 may be a software implementation of a physical machine that runs programs as if they were executing on a physical, non-virtualized machine. Each of the VMs 1808, and that part of hardware 1804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1808 on top of the hardware 1804 and corresponds to the application 1802.

Hardware 1804 may be implemented in a standalone network node with generic or specific components. Hardware 1804 may implement some functions via virtualization. Alternatively, hardware 1804 may be part of a larger cluster of hardware (e.g. such as in a data center or CPE) where many hardware nodes work together and are managed via management and orchestration 1810, which, among others, oversees lifecycle management of applications 1802. In some embodiments, hardware 1804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1812 which may alternatively be used for communication between hardware nodes and radio units.

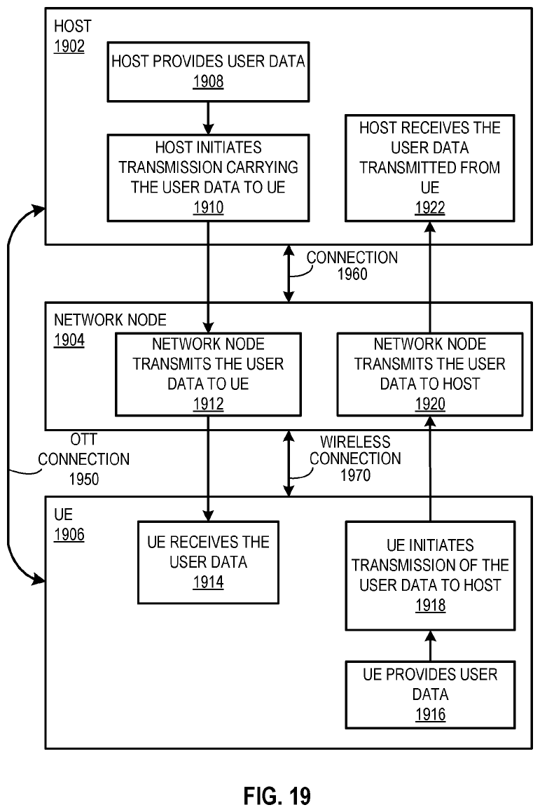

FIG. 19 shows a communication diagram of a host 1902 communicating via a network node 1904 with a UE 1906 over a partially wireless connection in accordance with some embodiments. Example implementations, in accordance with various embodiments, of the UE (such as a UE 1412a of FIG. 14 and/or UE 1500 of FIG. 15), network node (such as network node 1410a of FIG. 14 and/or network node 1600 of FIG. 16), and host (such as host 1416 of FIG. 14 and/or host 1700 of FIG. 17) discussed in the preceding paragraphs will now be described with reference to FIG. 19.

Like host 1700, embodiments of host 1902 include hardware, such as a communication interface, processing circuitry, and memory. The host 1902 also includes software, which is stored in or accessible by the host 1902 and executable by the processing circuitry. The software includes a host application that may be operable to provide a service to a remote user, such as the UE 1906 connecting via an over-the-top (OTT) connection 1950 extending between the UE 1906 and host 1902. In providing the service to the remote user, a host application may provide user data which is transmitted using the OTT connection 1950.

The network node 1904 includes hardware enabling it to communicate with the host 1902 and UE 1906. The connection 1960 may be direct or pass through a core network (like core network 1406 of FIG. 14) and/or one or more other intermediate networks, such as one or more public, private, or hosted networks. For example, an intermediate network may be a backbone network or the Internet.

The UE 1906 includes hardware and software, which is stored in or accessible by UE 1906 and executable by the UE's processing circuitry. The software includes a client application, such as a web browser or operator-specific “app” that may be operable to provide a service to a human or non-human user via UE 1906 with the support of the host 1902. In the host 1902, an executing host application may communicate with the executing client application via the OTT connection 1950 terminating at the UE 1906 and host 1902. In providing the service to the user, the UE's client application may receive request data from the host's host application and provide user data in response to the request data. The OTT connection 1950 may transfer both the request data and the user data. The UE's client application may interact with the user to generate the user data that it provides to the host application through the OTT connection 1950.

The OTT connection 1950 may extend via a connection 1960 between the host 1902 and the network node 1904 and via a wireless connection 1970 between the network node 1904 and the UE 1906 to provide the connection between the host 1902 and the UE 1906. The connection 1960 and wireless connection 1970, over which the OTT connection 1950 may be provided, have been drawn abstractly to illustrate the communication between the host 1902 and the UE 1906 via the network node 1904, without explicit reference to any intermediary devices and the precise routing of messages via these devices.

As an example of transmitting data via the OTT connection 1950, in step 1908, the host 1902 provides user data, which may be performed by executing a host application. In some embodiments, the user data is associated with a particular human user interacting with the UE 1906. In other embodiments, the user data is associated with a UE 1906 that shares data with the host 1902 without explicit human interaction. In step 1910, the host 1902 initiates a transmission carrying the user data towards the UE 1906. The host 1902 may initiate the transmission responsive to a request transmitted by the UE 1906. The request may be caused by human interaction with the UE 1906 or by operation of the client application executing on the UE 1906. The transmission may pass via the network node 1904, in accordance with the teachings of the embodiments described throughout this disclosure. Accordingly, in step 1912, the network node 1904 transmits to the UE 1906 the user data that was carried in the transmission that the host 1902 initiated, in accordance with the teachings of the embodiments described throughout this disclosure. In step 1914, the UE 1906 receives the user data carried in the transmission, which may be performed by a client application executed on the UE 1906 associated with the host application executed by the host 1902.

In some examples, the UE 1906 executes a client application which provides user data to the host 1902. The user data may be provided in reaction or response to the data received from the host 1902. Accordingly, in step 1916, the UE 1906 may provide user data, which may be performed by executing the client application. In providing the user data, the client application may further consider user input received from the user via an input/output interface of the UE 1906. Regardless of the specific manner in which the user data was provided, the UE 1906 initiates, in step 1918, transmission of the user data towards the host 1902 via the network node 1904. In step 1920, in accordance with the teachings of the embodiments described throughout this disclosure, the network node 1904 receives user data from the UE 1906 and initiates transmission of the received user data towards the host 1902. In step 1922, the host 1902 receives the user data carried in the transmission initiated by the UE 1906.

One or more of the various embodiments improve the performance of OTT services provided to the UE 1906 using the OTT connection 1950, in which the wireless connection 1970 forms the last segment. More precisely, the teachings of these embodiments may improve e.g., the data rate, latency, power consumption and thereby provide benefits such as e.g., reduced user waiting time, relaxed restriction on file size, improved content resolution, better responsiveness, extended battery lifetime.

In an example scenario, factory status information may be collected and analyzed by the host 1902. As another example, the host 1902 may process audio and video data which may have been retrieved from a UE for use in creating maps. As another example, the host 1902 may collect and analyze real-time data to assist in controlling vehicle congestion (e.g., controlling traffic lights). As another example, the host 1902 may store surveillance video uploaded by a UE. As another example, the host 1902 may store or control access to media content such as video, audio, VR or AR which it can broadcast, multicast or unicast to UEs. As other examples, the host 1902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1950 between the host 1902 and UE 1906, in response to variations in the measurement results. The measurement procedure and/or the network functionality for reconfiguring the OTT connection may be implemented in software and hardware of the host 1902 and/or UE 1906. In some embodiments, sensors (not shown) may be deployed in or in association with other devices through which the OTT connection 1950 passes; the sensors may participate in the measurement procedure by supplying values of the monitored quantities exemplified above, or supplying values of other physical quantities from which software may compute or estimate the monitored quantities. The reconfiguring of the OTT connection 1950 may include message format, retransmission settings, preferred routing etc.; the reconfiguring need not directly alter the operation of the network node 1904. Such procedures and functionalities may be known and practiced in the art. In certain embodiments, measurements may involve proprietary UE signaling that facilitates measurements of throughput, propagation times, latency and the like, by the host 1902. The measurements may be implemented in that software causes messages to be transmitted, in particular empty or ‘dummy’ messages, using the OTT connection 1950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method performed by a user equipment (UE) in communication with a network node, the method comprising:
receiving a sounding reference signal (SRS) configuration, the SRS configuration comprising configuration of at least two SRS ports; and
sending a power report to the network node, the power report comprising information of a power relation between at least two different SRS ports, wherein the power report is associated with a transmission of the at least two SRS ports.

2. The method of claim 1, wherein the at least two SRS ports are contained in one or more SRS resource sets or in one or more SRS resources.

3. (canceled)

4. (canceled)

5. The method of claim 1, further comprising receiving a configuration for the power report or a trigger to send the power report, from the network node.

6. (canceled)

7. (canceled)

8. The method of claim 1, wherein the information of power relation between at least two SRS ports comprises a difference in the power between the at least two SRS ports.

9. (canceled)

10. (canceled)

11. (canceled)

12. (canceled)

13. The method of claim 1, wherein the information of power relation between the at least two SRS ports comprises an indication of the power of the strongest SRS port and a power relative to the power of the strongest SRS port for the remaining SRS ports.

14. The method of claim 1, wherein the information of power relation between the at least two SRS ports comprises an indication of a power relative to a power of a specific SRS port.

15. (canceled)

16. The method of claim 1, wherein the information of power relation between the at least two SRS ports comprises an indication of a power relative to a specific SRS port to be within a range.

17. (canceled)

18. The method of claim 1, further comprising determining that a power difference between the at least two SRS ports exceeds a threshold value.

19. (canceled)

20. (canceled)

21. The method of claim 1, wherein the power report comprises a plurality of power reports corresponding to multiple serving cells or a subset of a plurality of serving cells.

22. (canceled)

23. (canceled)

24. The method of claim 1, wherein the power report comprises a plurality of power reports corresponding to one or more serving cells in which an SRS port has been transmitted recently.

25. The method of claim 1, wherein the power report is associated with the latest transmission of one or more of the at least two SRS ports.

26. The method of claim 1, wherein sending the power report comprises sending a dynamic signalling, wherein the dynamic signalling is one of UCI and MAC-CE.

27. A method performed by a network node in communication with a user equipment (UE), the method comprising:
sending a sounding reference signal (SRS) configuration to the UE, the SRS configuration comprising configuration for at least two SRS ports; and
receiving a power report from the UE, the power report comprising information of power relation between the at least two SRS ports, wherein the power report is associated with a transmission of the at least two SRS ports.

28. The method of claim 27, wherein the at least two SRS ports are contained in or more SRS resource sets or in one or more SRS resources.

29. (canceled)

30. (canceled)

31. The method of claim 27, further comprising sending a configuration for the power report.

32. (canceled)

33. The method of claim 27, further comprising estimating a downlink channel based on the received one or more SRS and the received power report.

34. (canceled)

35. (canceled)

36. (canceled)

37. (canceled)

38. (canceled)

39. (canceled)

40. (canceled)

41. (canceled)

42. The method of claim 27, wherein the information of power relation between the at least two SRS ports comprises an indication of a power relative to a specific SRS port to be within a range.

43. The method of claim 27, wherein the power report comprises a plurality of power reports corresponding to multiple serving cells or a subset of a plurality of serving cells.

44. (canceled)

45. (canceled)

46. (canceled)

47. (canceled)

48. The method of claim 27, wherein receiving the power report comprises receiving a dynamic signalling, which is one of UCI and MAC-CE.

49. A user equipment (UE) comprising processing circuitry and network interface, the processing circuitry configured to:
receive a sounding reference signal (SRS) configuration, the SRS configuration comprising configuration of at least two SRS port; and
send a power report to the network node, the power report comprising information of a power relation between at least two different SRS ports, wherein the power report is associated with a transmission of the at least two SRS ports.

50. (canceled)

51. (canceled)
